(19) United States
(12) Patent Application Publication
(10) Pub. No.: US 2025/0008133 A1
(43) Pub. Date: Jan. 2, 2025

(54) SYSTEM AND METHOD FOR OPTIMIZING BILL OF MATERIAL COST AND POWER PERFORMANCE OF GRAPHICS PROCESSING UNIT GPU CORE

(71) Applicant: TriSpace Technologies (OPC) Pvt Ltd., Bengaluru (IN)

(72) Inventors: Narasimhan Vijay Anand, Bengaluru (IN); Mohammed Amrin Bushra Taj, Bengaluru (IN); Akshay Madavalappil Ramesh, Bengaluru (IN); Lellapalli Anagha, Bengaluru (IN); Kamarsu Venkata Sriya, Bengaluru (IN)

(21) Appl. No.: 18/357,534

(22) Filed: Jul. 24, 2023

(30) Foreign Application Priority Data
Jun. 30, 2023 (IN) 202341044078

(51) Int. Cl. H04N 19/42; G06T 1/20; H04N 19/86

(52) U.S. Cl. CPC H04N 19/42; G06T 1/20; H04N 19/86

(57) ABSTRACT

The present invention provides a system and method for optimizing BOM cost of Graphics Processing Unit GPU core. The system (100) comprises a GPU with typical compute unit and instruction set of a GPU but the video SIMD instructions lacking saturation logic (101), wherein Video codec encoder/decoder modules is implemented. In-loop Deblocking filter, post-processing filtering module (102) are implemented in the GPU. Removing the logic hardware used to implement saturation in the video SIMD instructions helps in lowering the BoM cost and the inventive steps helps in achieving bit-exact results without saturation logic. The power consumed without saturation logic is lesser than one in with saturation logic is used, thus giving value additions to platform SoC designers and makers for using lo BoM cost GPU with better power performance.

### CROSS-REFERENCE TO RELATED APPLICATIONS

The present application claims priority to Indian patent application serial no. IN 202341044078, filed Jun. 30, 2023, herein incorporated by reference in its entirety.

### FIELD OF THE INVENTION

The present invention relates to a system and method for optimizing Bill of Material (BoM) cost and power-performance of Graphics Processing Unit (GPU) core. More specifically, the present invention relates to optimizing BOM cost of GPU core by implementing video codec encoder, decoder, in-loop filtering/post-processing filtering (Deblocking filters) on a GPU with video Single Instruction Multiple Data (SIMD) instructions without saturation logic hardwired in the video SIMD instructions with control software executing in a Central Processing Unit (CPU) on the platform System-On-Chip (SoC).

### BACKGROUND OF THE INVENTION

Platform SoC typically consists of CPU(s) cores, DSP(s) cores, and a GPU core. Platform SoC is used in building different kind of handheld gadgets such as Mobile handsets, Drones, Battery management system, and so on. Compute intensive video codecs are implemented on the DSP(s) sometimes assisted with a hardware co-processor.

There are various video compression standards such as MPEG-1, MPEG-2, MPEG-4, H.264, H.265, H.266, AV1, VP8, VP10 and many more upcoming standards. The codecs running on the DSP(s) in the platform SoC consume a lot of power. Recent trends explore design implementation of video codecs on GPU with control software running on CPU.

The high loading of processor in video communication causes lot of power consumption, as a result the battery life of device usage is drastically reduced in video communication.

The GPU core Instruction Set Architecture (ISA) has saturation logic in built into the video SIMD instructions. The saturation logic in each instruction cost few hundreds/thousands of Gates which increase the chip area and BOM cost of GPU core. Having a GPU core ISA with only SIMD extensions and lacking saturation logic except for three instructions namely ADD, SUB and a dedicated SAT instruction. The BoM cost of resulting GPU core is much lesser than GPU with saturation logic. Getting bit-exact results and power optimal solution on GPU with this video SIMD instruction without saturation logic is challenging. This invention achieves results of implementing video codec encoder, decoder, in-loop filtering module on GPU whilst achieving better power performance and lowering BoM cost by using GPU core video SIMD instruction without saturation logic built.

The U.S. patent document U.S. Pat. No. 10,390,309 titled “System and method for optimizing power consumption in mobile devices” discloses a method and apparatus for optimizing power consumption in mobile devices by suitable Instruction Set Architectural feature changes and optimal implementation of speech codecs. However, the solution is aimed at primary targeting the voice call use case and targeting CPU.

The U.S. patent document U.S. Pat. No. 11,330,526 titled “System and method for optimizing power consumption in video communication in mobile devices” discloses a method and apparatus for optimizing power consumption in mobile devices by suitable Instruction Set Architectural feature changes and optimal implementation of video codecs. However, the solution is aimed at power optimization of the video call use case using CPU and DSP cores.

### SUMMARY OF THE INVENTION

The present invention overcomes the drawbacks in the prior art and provides a system and method for optimizing BoM cost and power-performance of GPU for use in platform SoC of Mobile device.

The system comprises a CPU and a GPU with video SIMD instructions in the platform SoC. Digital video data of resolution 8 bits, 10 bits, is provided from the CPU to GPU for encoding/decoding. The control software is implemented on the CPU while computationally intensive encoder, decoder, filtering modules are implemented in the GPU.

In an embodiment of the invention, digital video signal is encoded according to compression standards H.264 or any other suitable standard for application. The various encoding tools such as Intra prediction, Motion Compensation, filtering is implemented in the GPU with video SIMD instruction without saturation logic. The current consumption in the GPU is less than the case when GPU has video SIMD instruction having saturation logic, and has added advantage of lowering BOM cost of GPU.

The system also includes video codec decoder. The video codec decoder module is configured to decode the compressed video signal. The decoded video signal is then post processed using deblocking filter module. All these modules are implemented in a GPU core.

Thus, the present invention provides method to optimize the BoM cost of GPU while saving power consumption in a video call in the product device as against GPU with video SIMD instruction having saturation logic.

The GPU core in platform SoC is replaced with GPU core having less chip area and thereby reducing BOM cost of GPU.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a block diagram of a system for implementing video codecs in the platform SoC with CPU and GPU, according to one embodiment of the invention.

FIG. 2 illustrates a method for optimizing BoM cost of GPU, according to one embodiment of the invention.

FIG. 3 illustrates a method for optimizing BoM cost of GPU whilst implementing video codecs in the platform SoC, according to one embodiment of the invention.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

In order to more clearly and concisely describe and point out the subject matter of the claimed invention, the following definitions are provided for specific terms, which are used in the following written description.

The present invention provides a system and method for optimizing BoM cost and power-performance of GPU. The system comprises a CPU wherein, all control software needed for video codec. The video encoder, decoder, filtering is implemented on a GPU with video SIMD instruction. The implementation of video codecs and post-processing modules (deblocking filter) in GPU with video SIMD instruction without saturation logic instead of GPU with saturation logic results in up-to several thousand logic gates reduction in platform SoC.

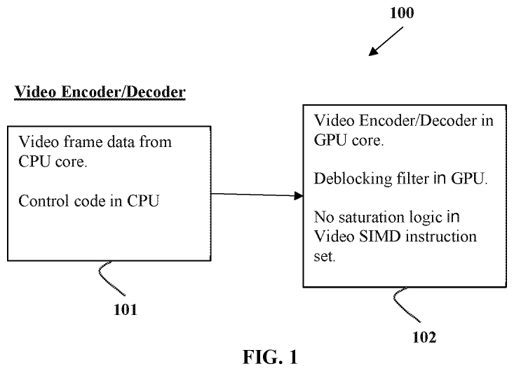

FIG. 1 illustrates a block diagram of a system for implementing video codecs in mobile devices, according to one embodiment of the invention. In a preferred embodiment, the system comprises a CPU core (101) which is tasked with control software for encoding/decoding. The encoder, decoder, in-loop filtering/post processing module (deblocking filter) is implemented on the GPU with video SIMD instructions (102).

The various coding tools of the digital video compression standard specification namely intra prediction, Motion Estimation/inter prediction, motion compensation, transform, quantization, filtering is implemented on the GPU with video SIMD instructions. The current consumption in the SoC is reduced while reducing BoM cost (102) compared to an implementation on a GPU with saturation logic in the video SIMD instructions.

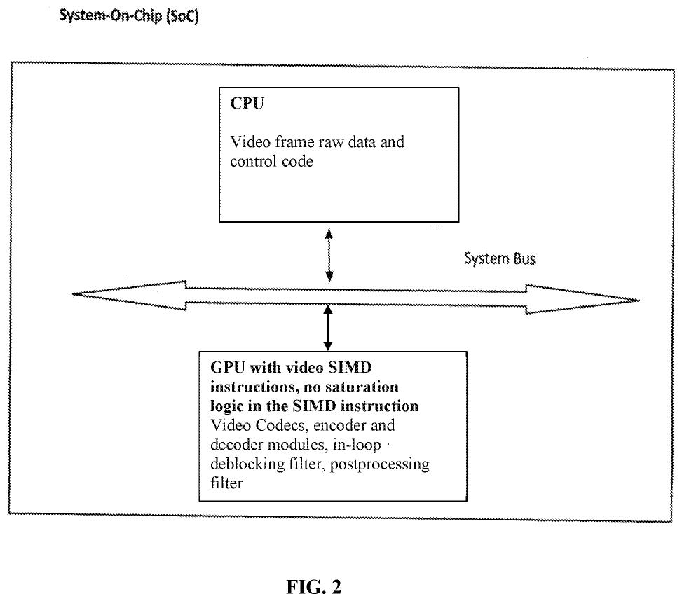

FIG. 2 In an embodiment of the invention, the implementation of video codec and post-processing (deblocking filter) modules on GPU core results in efficient implementation of video codecs without increase in current consumption whilst reducing BOM cost of platform SoC. The Architecture of the SoC contains CPU(s) and GPU with video SIMD instructions without saturation logic. Thus, lower BoM cost platform SoC is built while still providing better power consumption in the GPU in the present invention.

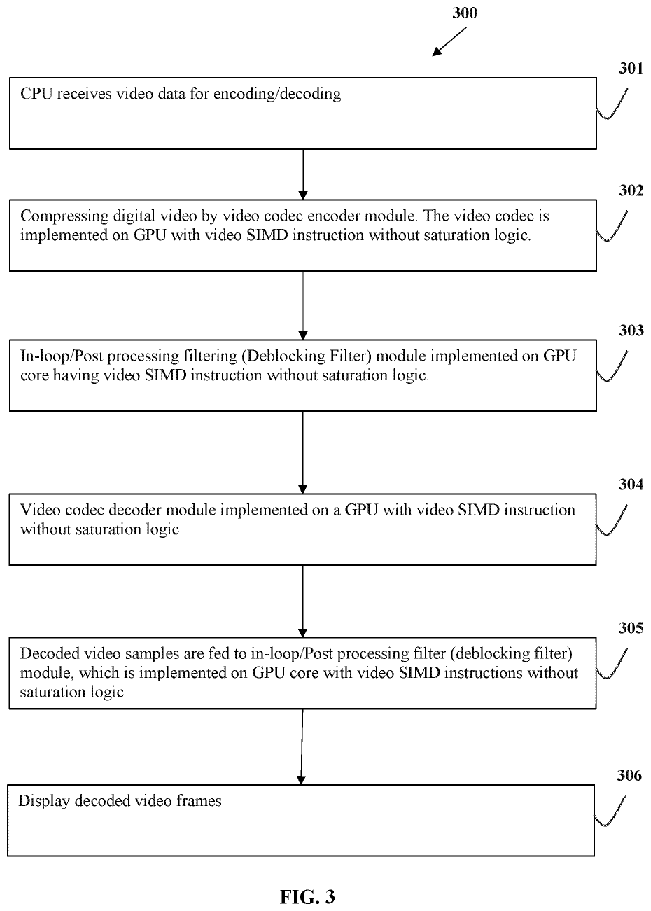

FIG. 3 illustrates the method for optimizing power consumption in video codec modules in the GPU, according to one embodiment of the invention. In a preferred embodiment, the method initiates with the step of receiving and recording raw video at step 301.

At step 302, video frame samples are encoded by a video codec encoder module. The video encoder module is implemented on GPU with video SIMD instructions without saturation logic. The deblocking filter and other post processing is implemented on GPU core at step 303. The current consumption in running the video encoder is better compared to implementation using video SIMD instructions with saturation logic, and achieving bit-exact results overcoming the limitation of lack of saturation logic in the instructions.

At step 304, the compressed video signal is decoded by the video codec decoder (102).

At step 305, decoded video is deblocking filtered and post-processed to get output video frame (102).

The inventive step in encoder, decoder, in-loop/post-processing (deblocking) module implemented on GPU with video SIMD instructions is described now. The video frame samples are usually 8 bits. 10 bit video samples are supported nowadays. In intra prediction module, the intra block size could vary from 4×4 to 32×32 depending on the video standard. The reference samples are also 8 bit or 10 bit and are subjected to filtering. The output of this is still 8 or 10 bits, and can fit within 16-bit span of a 32-bit register. The filtering operation is 3 tap filter followed by downscaling, the intermediate results still within 16-bit span. Turning off saturation is thus safe, and the instruction set can have MAC instruction without saturation embedded into it and SIMD optimization is possible. The input to transform module in Intra prediction module is thus 9 or 11 bits. The transform module is implemented so as to ensure intermediate and output results don't cross 16-bit span. Thus, again saturation can be turned off and MAC instruction without saturation embedded is useful and SIMD optimization is possible. In inter block coding tool, the input pixel values are 8 or 10 bits. Motion estimation can be performed efficiently and correctly based on Sum of Absolute Difference (SAD) so that it doesn't cross 16-bit span. Input to transform of inter-coded block is 9 bits or 11-bits, and this can also be processed within 16-bit span of intermediate/final results. Thus, saturation can be turned off, enabling Instruction Set Architecture (ISA) to have MAC without saturation embedded in the instruction and SIMD optimization is possible, thus saving Bill of Material (BOM) cost and giving power savings in optimization. In deblocking module, the block size could vary from 4×4 to 32×32 depending on the video standard. The filtering operation is 3 tap filter, the intermediate results still within 16-bit span. Turning off saturation is thus safe, and the instruction set can be constructed without saturation embedded into it and SIMD optimization is possible, thus saving Bill of Material (BOM) cost and giving better power performance as in a GPU with saturation logic of deblocking filter.

Thus, the present invention provides a method to optimize the BoM cost of GPU.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Software includes applications and algorithms. Software may be implemented in a smart phone, tablet, or personal computer, in the cloud, on a wearable device, or other computing or processing device. Software may include logs, journals, tables, games, recordings, communications, SMS messages, Web sites, charts, interactive tools, social networks, VOIP (Voice Over Internet Protocol), e-mails, and videos.

In some embodiments, some or all of the functions or process(es) described herein and performed by a computer program that is formed from computer readable program code and that is embodied in a computer readable medium. The phrase “computer readable program code” includes any type of computer code, including source code, object code, executable code, firmware, software, etc. The phrase “computer readable medium” includes any type of medium capable of being accessed by a computer, such as read only memory (ROM), random access memory (RAM), a hard disk drive, a compact disc (CD), a digital video disc (DVD), or any other type of memory.

All publications and patent applications mentioned in this specification are herein incorporated by reference to the same extent as if each individual publication or patent application was specifically and individually indicated to be incorporated by reference.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

We claim:

1. A system (100) for optimizing Bill of Material (BoM) cost and power performance of Graphics Processing Unit (GPU) core, the system (100) comprising:
a. a Central Processing Unit (CPU) core for executing control code (101);
b. video codec encoder and decoder modules, in-loop filter/post-processing modules including deblocking filter (102), wherein the video codec encoder and decoder modules, filtering module (102) is implemented in a GPU core with video SIMD instructions;
c. saturation is turned off in the video codec encoder, decoder, in-loop filtering/post processing modules (deblocking filter); and
d. the Arithmetic Logic Unit (ALU) of GPU is designed to have video SIMD instructions without saturation logic in the critical instructions, wherein the critical instruction include Multiply and Accumulate (MAC) and shift instructions.

2. The system as claimed in claim 1, wherein the video codec module (101, 102) includes MPEG-1, MPEG-2, MPEG-4, H.264, H.265, H.266, AV1, VP8, VP10 standard video codecs.

3. The system as claimed in claim 1, wherein the BoM cost of GPU core is reduced compared to GPU core with video SIMD instructions having saturation logic to implement video codec encoder and decoder modules, in-loop/post-processing (deblocking filter).

4. A method for optimizing BoM cost and power performance of GPU core, the method comprising the steps of:
a. executing control code in a CPU core (101);
b. implementing video codec encoder, decoder, in-loop/post-processing Filter modules including deblocking filter (102), wherein the filtering module (102) is implemented in a GPU core with video SIMD instruction;
c. saturation is turned off in the video codec encoder, decoder, in-loop filtering/post processing module (deblocking filter); and
d. the ALU of GPU is designed to have video SIMD instructions without saturation logic in the critical instructions, wherein the critical instruction include but not limited to MAC and shift instructions.

5. The method as claimed in claim 4, wherein the video codec modules (101, 102) include MPEG-1, MPEG-2, MPEG-4, H.264, H.265, H.266, AV1, VP8, VP10 standard video codecs.
